(19) United States
(12) Patent Application Publication
(10) Pub. No.: US 2024/0042538 A1
(43) Pub. Date: Feb. 8, 2024

(54) PORTABLE PIPE THREADER

(71) Applicant: MILWAUKEE ELECTRIC TOOL CORPORATION, Brookfield, WI (US)

(72) Inventors: Joseph J. PECHSTEIN, West Bend, WI (US); Sean T. KEHOE, Hartland, WI (US); Sam L. BERTZ, Fox Point, WI (US); Aaron C. GRODE, Brookfield, WI (US); Matthew R. WOLF, Wauwatosa, WI (US); Joseph C. ILLG, Grafton, WI (US); Peter J. DAVIES, Milwaukee, WI (US)

(21) Appl. No.: 18/362,275

(22) Filed: Jul. 31, 2023

Related U.S. Application Data
(60) Provisional application No. 63/394,456, filed on Aug. 2, 2022.

(51) Int. Cl. B23G 1/24; B23B 31/163; B25H 1/04; B23G 1/52; B23G 1/48

(52) U.S. Cl. CPC B23G 1/24; B23B 31/16004; B25H 1/04; B23G 1/52; B23G 1/48

(57) ABSTRACT

A portable pipe threader includes a collapsible stand, a housing supported by the collapsible stand, the housing supporting a battery-powered drive assembly, a first set of guide rails extending from a first end of the housing and supporting pipe threading tools, and a second set of guide rails extending from a second end of the housing and supporting a roll groover. The roll groover is configured to swing about a first one of the second set of guide rails to selectively engage a second one of the second set of guide rails.

### CROSS-REFERENCE TO RELATED APPLICATIONS

This application claims priority to co-pending U.S. Provisional Patent Application 63/394,456 filed on Aug. 2, 2022, the entire content of which is incorporated herein by reference.

### FIELD OF THE INVENTION

The present invention relates to pipe threaders, and more particularly to portable pipe threaders.

### BACKGROUND OF THE INVENTION

Portable pipe threaders include a stand and a carriage mounted to the stand having multiple pipe threading tools. These tools are usually a die holder including multiple dies, a cutter, and a reamer. Typically, a motor transmits torque to a spindle to which a pipe is clamped for rotating the pipe with respect to the tools. The motor is an AC motor that receives power from a remote power source (e.g., via a power cord) and is usually controlled using a pedal, which upon actuation, triggers the motor to begin rotating the pipe.

### SUMMARY OF THE INVENTION

The present invention provides, in one aspect, a portable pipe threader including a collapsible stand. A housing is supported by the collapsible stand, the housing supporting a battery-powered drive assembly. A first set of guide rails extends from a first end of the housing and supporting pipe threading tools. A second set of guide rails extends from a second end of the housing and supporting a roll groover. The roll groover is configured to swing about a first one of the second set of guide rails to selectively engage a second one of the second set of guide rails.

The present invention provides, in another aspect, a portable pipe threader including a collapsible stand including a first leg and a second leg coupled to the first leg with a first rotatable joint. A housing is supported by the collapsible stand, the housing supporting a battery-powered drive assembly. An assist spring has a first end coupled to a lower portion of the first leg and a second end coupled to an upper portion of the second leg. The assist spring exerts a bias force urging the collapsible stand to an upright deployed position for supporting the housing at an elevated height above a work surface. An adjustable stop is operable to toggle between a first, unlocked position in which the adjustable stop provides clearance for the second end of the assist spring to allow movement to the upright deployed position, and a second, locked position in which the adjustable stop is positioned to block movement of the second end of the assist spring to prevent movement to the upright deployed position.

The present invention provides, in yet another aspect, a portable pipe threader including a housing supporting a battery-powered drive assembly. A carriage supports pipe threading tools at a first end of the housing. A spindle assembly includes a chuck positioned at the first end for selectively clamping a pipe for rotation by the drive assembly about a central axis. The chuck includes a plurality of jaws movable toward and away from the central axis, a jaw plate slidingly supporting each of the plurality of jaws with a radial sliding interface, and a scroll plate coupled to an internal side of each of the plurality of jaws and rotatable to simultaneously move the plurality of jaws toward or away from the central axis. The internal sides of the plurality of jaws differ from each other and only operate with concentricity when each of the plurality of jaws is in a prescribed position on the jaw plate. Improper positioning of the plurality of jaws on the jaw plate is prevented by providing sliding interface profiles that are different from each other such that interchangeability is prevented.

Other features and aspects of the invention will become apparent by consideration of the following detailed description and accompanying drawings.

### BRIEF DESCRIPTION OF THE DRAWINGS

FIG. 1 is a perspective view of a portable pipe threader in accordance with an embodiment of the invention. The portable pipe threader includes a stand shown in a deployed position.

FIG. 2 is a detail perspective view of a portion of the portable pipe threader of FIG. 1.

FIG. 3 is a cross-section view of the stand of the portable pipe threader in a stowed, unlocked configuration.

FIG. 4 is a cross-section view of the stand in a stowed, locked configuration.

FIG. 4A is a perspective view of the stand in the stowed, locked configuration.

FIG. 5 is a perspective view of a dual chuck spindle assembly of the portable pipe threader of FIG. 1.

FIG. 6 is a detail view of one end of the dual chuck assembly of FIG. 5, shown with a jaw plate removed to expose a scroll plate that drives the three chuck jaws synchronously inward or outward with respect to a central chuck axis.

FIG. 7 is a detail perspective view of a first chuck jaw interface with the jaw plate.

FIG. 8 is a detail perspective view of a second chuck jaw interface with the jaw plate.

FIG. 9 is a detail perspective view of a third chuck jaw interface with the jaw plate.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

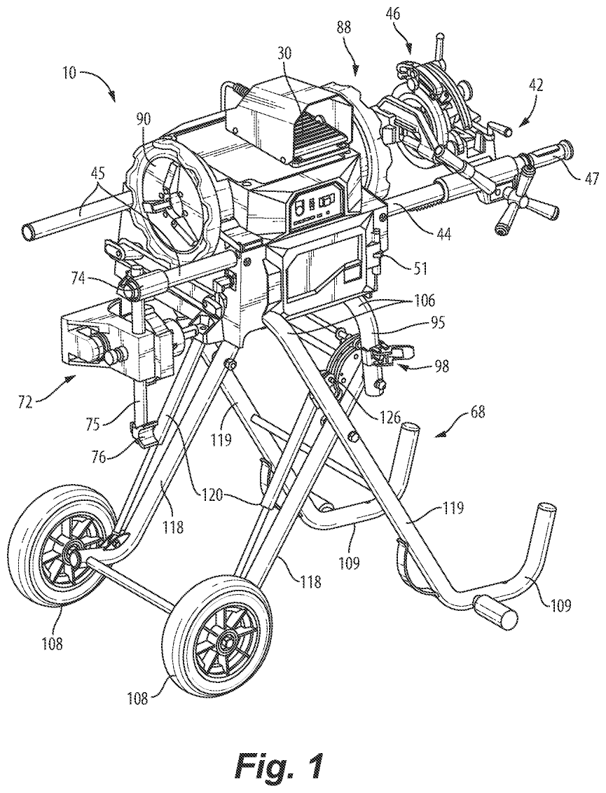

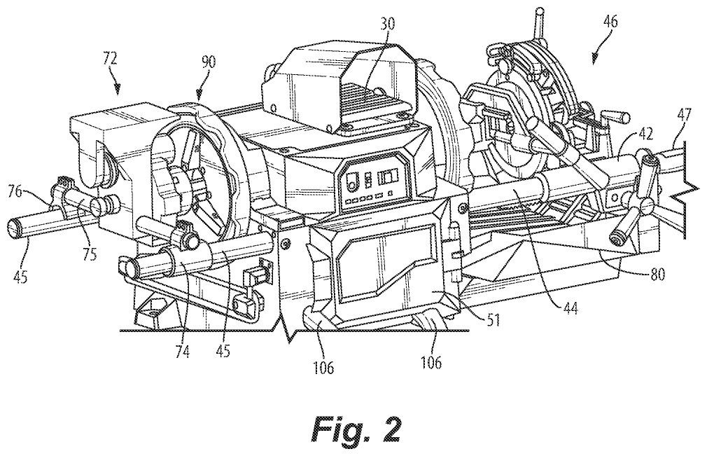

With reference to FIG. 1, a portable pipe threader 10 includes a stand 68 and a housing 51 in which a drive assembly is located. The housing 51 can include a battery receptacle (not shown). Next to the housing 51, the pipe threader 10 includes a carriage 42 having a plurality of pipe threading tools 46 (e.g., thread dies to cut threads on the pipe, a cutter to trim excess pipe, and a reamer to smooth edges of the threaded or cut pipe) supported by the carriage 42. A first set of guide rails 44 extends from a first end of the housing 51 in a first direction, and a second set of guide rails 45 extends from an opposite, second end of the housing 51 in a second direction. The carriage 42 is slidably supported upon the first set of guide rails 44 which, in turn are supported by the housing 51 (which is then supported by the stand 68). Each rail of the first and second sets of guide rails 44, 45 can be formed continuous with a rail of the other set, or all the rails can be separately formed and separately secured to the housing 51. The first set of guide rails 44 are configured to support the carriage 42, which is slidable along the rails 44 to position the pipe threading tools 46 relative to a pipe mounted in the pipe threader 10. The guide rails 44 each include a guide handle 47 facilitating gripping and transport of the threader 10 with the attached stand 68. A catch basin 80 for lubricant is shown in FIG. 2 to extend below the first set of guide rails 44 and the pipe threading tools 46. As discussed in further detail below, the pipe threader 10 can further include a roll groover 72 mounted at the second or rear end of the pipe threader 10, adjacent the second end of the housing 51. The roll groover 72, which is supported on one or both of the guide rails 45, is thus mounted at an opposite end from the pipe threading tools 46.

The pipe threader drive assembly includes a motor (e.g., a brushless direct current motor) and a gear box coupled to the motor having an output gear. An electronic speed selection switch, such as a pedal 30, is provided and operable to selectively control the drive assembly (e.g., control a relative speed at which the pipe rotates). The drive assembly is powered by a battery pack (not shown) in selective electrical communication with the motor to provide electrical power to the motor. In some constructions, the battery pack and the motor can be configured as an 18 Volt high power battery pack and motor, such as the 18 Volt high power system disclosed in U.S. patent application Ser. No. 16/045,513 filed on Jul. 25, 2018 (now U.S. Patent Application Publication No. 2019/0044110), the entirety of which is incorporated herein by reference. In other constructions, the battery pack and the motor can be configured as an 80 Volt high power battery pack and motor, such as the 80 Volt battery pack and motor disclosed in U.S. patent application Ser. No. 16/025,491 filed on Jul. 2, 2018 (now U.S. Patent Application Publication No. 2019/0006980), the entirety of which is incorporated herein by reference. In such a battery pack, the battery cells within the battery pack have a nominal voltage of up to about 80 V. In some embodiments, the battery pack has a weight of up to about 6 lb. In some embodiments, each of the battery cells has a diameter of up to 21 mm and a length of up to about 71 mm. In some embodiments, the battery pack includes up to twenty battery cells. In some embodiments, the battery cells are connected in series. In some embodiments, the battery cells are operable to output a sustained operating discharge current of between about 30 A and about A. In some embodiments, each of the battery cells has a capacity of between about 3.0 Ah and about 5.0 Ah. And, in some embodiments of the motor when used with the 80 Volt battery pack, the motor has a power output of at least about 2760 W and a nominal outer diameter (measured at the stator) of up to about 80 mm. Details of the construction and operation of the pipe threader 10, except as specifically noted herein, can conform to those specified within U.S. Patent Application Publication No. 2021/0229200, the entire contents of which are incorporated by reference herein.

As shown in FIGS. 1 and 2, the roll groover 72 can be selectively deployed (FIG. 2) from a hanging, standby position (FIG. 1). In the standby position of FIG. 1, the roll groover 72 is supported by only one of the second set of guide rails 45 (e.g., a front guide rail). Thus, the roll groover 72 hangs down by its own weight from the one guide rail 45. In the standby position of FIG. 1, the roll groover 72 is not aligned with a rear chuck 90 of the spindle assembly. When the user is ready to use the roll groover 72, it can be rotated about the one guide rail 45 toward a top side of the other (rear) guide rail 45. Once in engagement with the other guide rail 45 as shown in FIG. 2, the roll groover 72 is stably supported and positioned in line with the rear chuck 90 for operation. To accomplish this, the roll groover 72 is provided with two different interfaces for the two guide rails 45, where the first or front interface includes a closed cylindrical mount 74 fully encircling the cylindrical-shaped first guide rail 45, and the second or rear interface includes an open (e.g., semi-cylindrical) mount 76 only partially engaging the (e.g., cylindrical) outer profile the second guide rail 45. A cross bar 75 can extend between the two mounts 74, 76 and a central portion of the cross bar 75 supports the operational tooling portion of the roll groover 72. There are no clamps provided for engagement of the roll groover 72 with either of the guide rails 45. As such, the roll groover 72 is simply and quickly assembled/disassembled and also simply and quickly moved between the deployed working position and the standby position. The roll groover 72 is operable to engage a pipe mounted in the spindle assembly of the pipe threader 10 to form a rolled groove for making mechanical pipe joints. A user of the pipe threader 10 is able to make quick change-overs between working on pipe with the pipe threading tools 46 at the first end and working on pipe with the roll groover 72 at the second end.

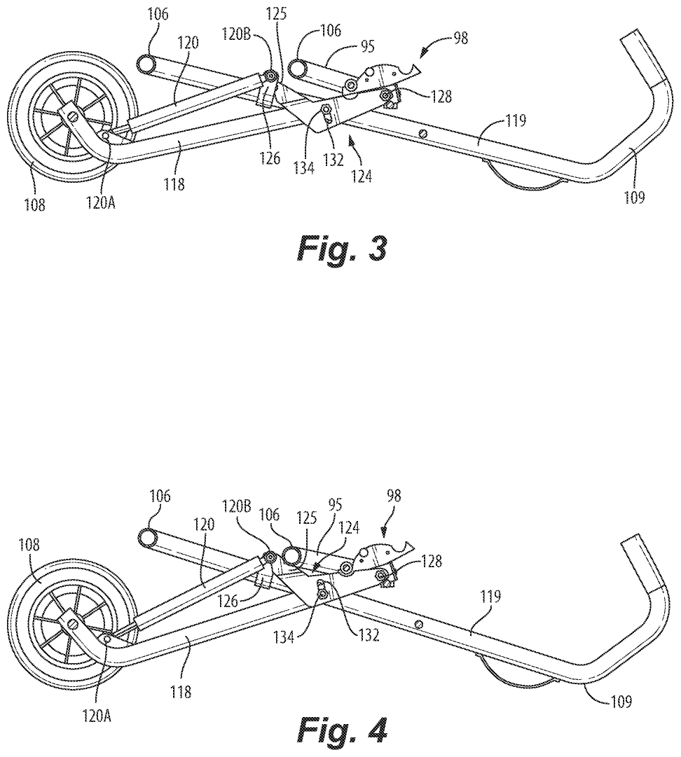

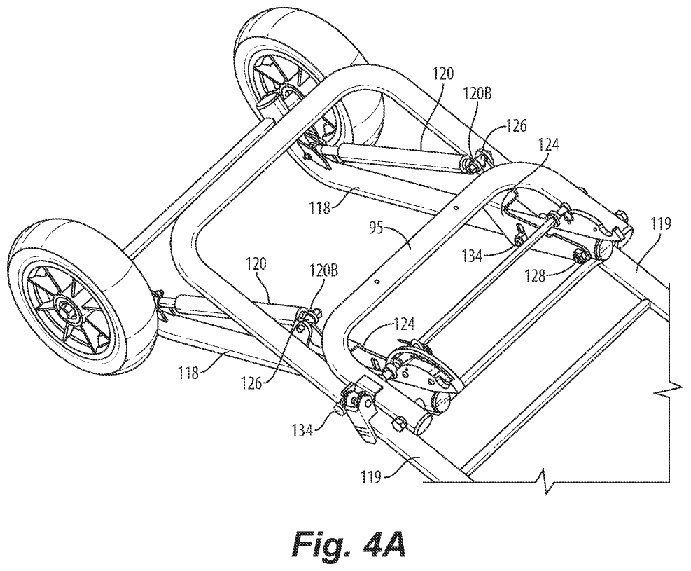

The stand 68 of the pipe threader 10 shown in FIG. 1 is shown in isolation in FIGS. 3 and 4 to better illustrate a stand locking mechanism. The stand 68 includes a plurality of mounts 106 to which the threader 10 is removably secured. The mounts 106 are generally at an upper end of the stand 68. At its lower end, the stand 68 can provide a wheeled ground engagement member 108 and a non-wheeled ground engagement member 109. The respective ground engagement members 108, 109 can be provided at the respective ends of two different pivotally-coupled legs 118, 119. The non-wheeled ground engagement member 109 at the end of the legs 119 can be handle or grip portions that double as feet when the stand 68 is deployed. The mounts 106 can be provided by the second leg 119 and a further upright support 95 coupled with a rotatable joint (e.g., fastener 128) to an upper end of the first leg 118.

Although not apparent from the central cross-section views of FIGS. 3 and 4, FIG. 1 illustrates that the stand 68 includes a first pair of pivotally-coupled legs 118, 119 at a first or front side of the pipe threader 10 and a second pair of pivotally-coupled legs 118, 119 at a second or rear side of the pipe threader 10. The remaining description of the features of the stand 68 with reference to FIGS. 3 and 4 will be understood as applying to one or both of the pairs of legs. As shown in FIG. 1, the stand 68 can be locked into an upstanding or deployed working position by a releasable latch or locking mechanism 98. The locking mechanism 98 can maintain the deployed working position of the stand 68 until manipulated to a releasing position by a user that allows the legs 118, 119 to collapse to the position of FIG. 3 or FIG. 4 under the weight of the pipe threader 10. The stand 68 collapses against the bias of a lift assist mechanism including one or more assist springs 120 (e.g., gas springs, sometimes also referred to as “gas struts”) that operate to urge the stand 68 toward the deployed working position. The assist spring 120 can provide continuous bias force urging the legs 118, 119 to a relative position corresponding to deployment. The assist spring 120, which is extendable (FIG. 1) and retractable (FIGS. 3 and 4) in length, can extend generally along the first leg 118, although not fully parallel thereto. A first end 120A of the assist spring 120 is secured to the first leg 118 adjacent the wheeled ground engagement member 108. A second end 120B of the assist spring 120 is secured to an upper portion of the second leg 119, above the pivot between the legs 118, 119. The second leg 119 can have a mount (e.g., bracket) 126 provided thereon for securing the second end 120B of the assist spring 120.

Although the assist spring 120 provides a benefit to the user in reducing the lifting force required to deploy the stand 68 upward, especially when the pipe threader 10 is mounted, the assist spring 120 will also tend to make the stand 68 willing to rise up on its own when the user decouples the pipe threader 10 and attempts to lift it off the stand 68. In order to prevent the nuisance of the stand 68 self-deploying when the pipe threader 10 is decoupled, an adjustable stop 124 (FIGS. 3 and 4) can be added to the stand 68 of the pipe threader 10 of FIGS. 1 and 2. The adjustable stop 124 is operable to retain the legs 118, 119 in the folded, collapsed position. As a reminder, the adjustable stop 124 shown in FIGS. 3 and 4 can be one of two similar adjustable stops—one for each pair of legs 118, 119. The cross-section of FIGS. 3 and 4 illustrates the adjustable stop 124 provided on the rear pair of legs 118, 119. As such, it can be appreciated that the adjustable stop 124 is provided on an interior-facing side of the legs 118, 119 rather than an exterior-facing side. However, the adjustable stop(s) 124 can incorporate other arrangements in alternate constructions.

As shown, the adjustable stop 124 consists of a rigid, pivoting bracket (e.g., constructed from a metal sheet). The adjustable stop 124 is pivotable between a first, unlocked position (FIG. 3) which does not obstruct the extension of the spring 120 and a second, locked position (FIG. 4) which obstructs the extension of the spring 120. A first or proximal end of the adjustable stop 124 (right side as shown) is pivotally coupled to the first leg 118, for example at or near an upper end of the first leg 118. The proximal end of the adjustable stop 124 can be pivotally coupled with a rotatable joint (e.g., fastener 128). The rotatable joint can be coaxial with or the same rotatable joint as that which pivotally connects the upright support 95 to the first leg 118. A distal end 125 of the adjustable stop 124 is provided adjacent the second end 120B of the assist spring 120 and the mount 126 when the stand 68 is collapsed. The distal end 125 of the adjustable stop 124 can be formed with a concave shape. Between the proximal and distal ends, the adjustable stop 124 has a central portion that serves as a pivoting range limiter. For example, the central portion of the adjustable stop 124 includes a slot 132 that receives an entrapped member (e.g., fastener 134) of the first leg 118. Thereby, the adjustable stop 124 has only a few degrees (e.g., 10 degrees or less) of pivotal range about the proximal end to move between the unlocked and locked positions. In the first limit position, which is the unlocked position of FIG. 3, the distal end 125 of the adjustable stop 124 provides clearance to the second end 120B of the assist spring 120 and the corresponding mount 126 on the leg 119, allowing movement of the legs 118, 119 to the deployed working position. In the second limit position, which is the locked position of FIG. 4, the distal end 125 of the adjustable stop 124 is positioned to contact the second end 120B of the assist spring 120 and/or the mount 126, preventing movement of the legs 118, 119 to the deployed working position. The contacted portion of the stand (e.g., a rounded boss portion of the mount 126, FIG. 4A) can have a shape complementary to the concave distal end 125 of the adjustable stop 124 so that the parts at least partially fit together to more positively secure the collapsed position of the stand 68. Alternate pairs of shapes may be provided to the same effect in other constructions. The user can set the adjustable stop 124 to the locked position and remove the pipe threader 10 from the stand 68 without the stand 68 raising up. Setting the allowability for the stand 68 to move from the collapsed position of the stand 68 is accomplished solely through the pivoting of the adjustable stop 124 (e.g., solely through the pivoting of the two adjustable stops 124—one on each side of the stand 68). The two stops 124 can be independently movable or connected for movement together.

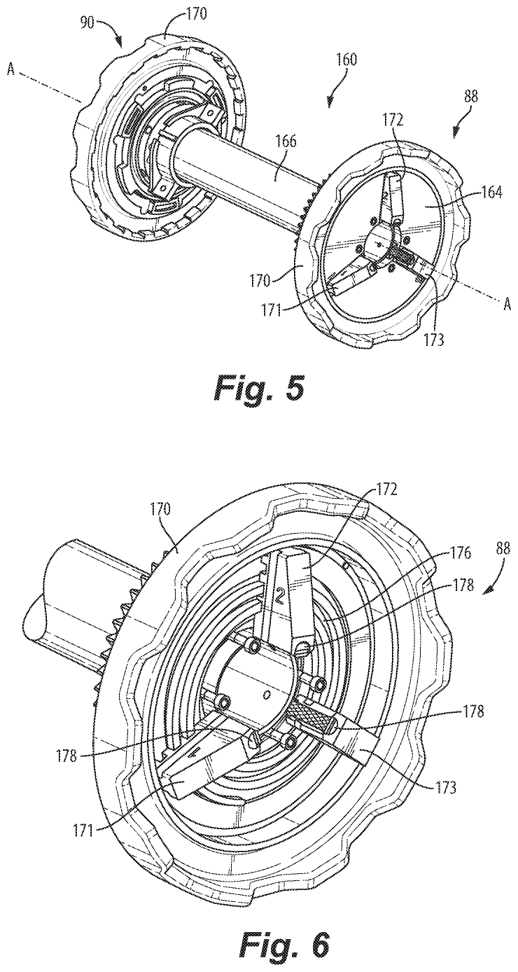

FIGS. 5 and 6 illustrate a spindle assembly 160 of the pipe threader 10, the spindle assembly 160 including multi jaw chucks 88, 90 at each end. Each chuck 88, 90 can have an outer jaw plate 164 with a central opening for receiving a pipe. The chucks 88, 90 are coupled to each other by a central spindle 166, although the chucks 88, 90 are separately operable for clamping/releasing. In particular, each chuck 88, 90 can have an independently operated hand wheel 170 for moving the corresponding jaws 171, 172, 173 radially in or out, depending on the direction of rotation. The plurality of jaws 171, 172, 173 of a particular one of the chucks 88, 90 are operable to all move synchronously together, either toward or away from a central axis A (also the pipe axis when the pipe is mounted). In the close-up view of FIG. 6, the outer jaw plate 164 is removed to reveal an inner scroll plate 176, which has a spiral drive surface axially facing and engaged with notched inner axial end surfaces of the respective jaws 171, 172, 173. The hand wheel 170 can be operable to drive rotation of the scroll plate 176, although circumferential clearance can be provided therebetween to allow the hand wheel 170 to hammer-drive the scroll plate 176. At the radially inward end, each of the jaws 171, 172, 173 has a replaceable insert 178 configured to establish the direct contact to the clamped pipe.

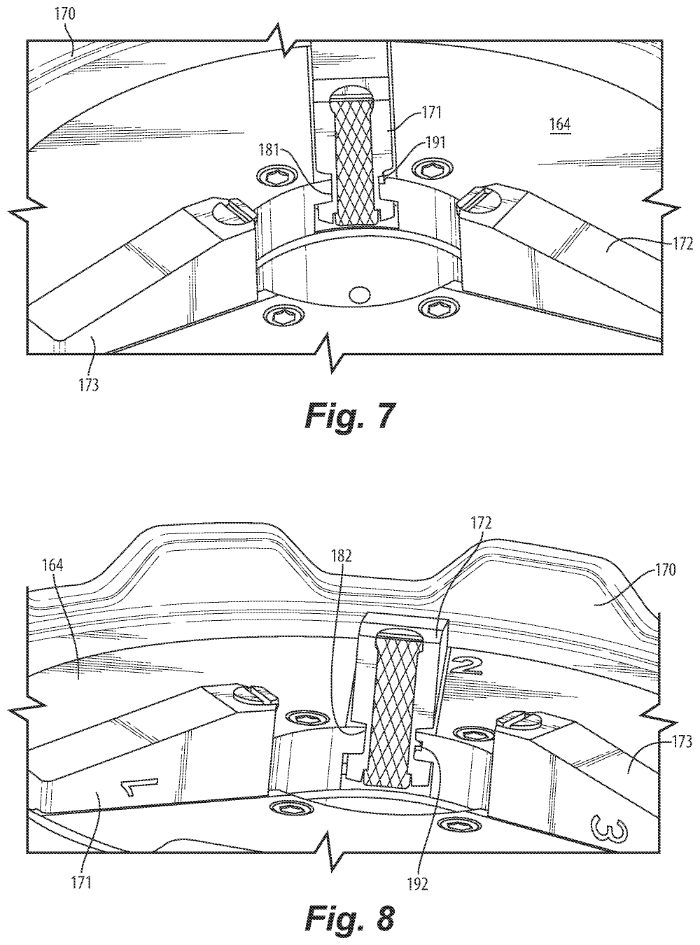

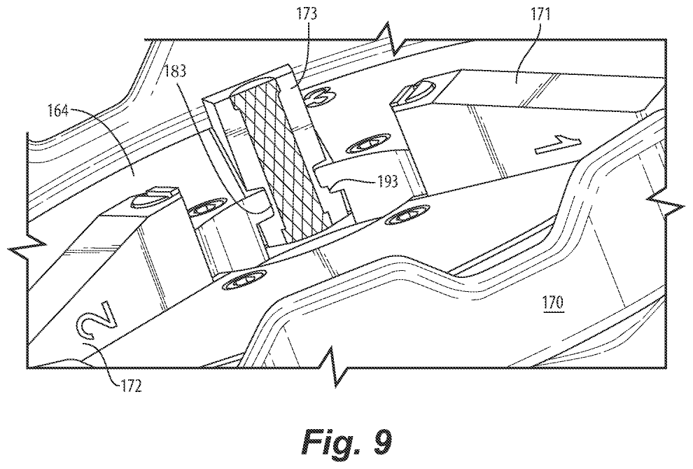

In order to guarantee concentricity during manipulation of either of the chucks 88, 90, and thus concentricity of a clamped pipe for working operation, the positions of the respective jaws 171, 172, 173 must correspond to prescribed positions. In other words, the individual jaws 171, 172, 173 within one of the chucks 88, 90 are not interchangeable with each other. Although this is typically the case with conventional chucks that utilize a scroll plate 176 like that shown, conventional jaws typically only differ from each other based on the configuration at the scroll plate engaging inner axial end surfaces—and are thus technically interchangeable with each other. The physical ability to interchange the jaws leads to a possibility of improper assembly and non-concentric operation. This has not conventionally been addressed, other than for example, ensuring practices for proper assembly at the time of manufacture and providing a visual indicator for the proper position in the event that field service is performed. As shown in FIGS. 7-9, the chucks 88, 90 of the present disclosure are constructed, along with the outer jaw plate 164, to provide a poka-yoke configuration that blocks improper jaw assembly configuration and guarantees assembly of the jaws 171, 172, 173 in only the prescribed positions that provide concentricity.

As shown in FIGS. 7-9, each jaw 171, 172, 173 has a radially-extending sliding interface fit with a corresponding slot 181, 182, 183 of the outer jaw plate 164. The slot and jaw interfaces have unique profiles, each of which is continuous in the radial direction to enable radial sliding. Each interface profile has a counter-clockwise side and an opposite clockwise side (as viewed from exterior to the chuck, along the central axis A). In the particular construction illustrated, the poka-yoke is provided by making the interface profiles unique from each other on one of the counter-clockwise and clockwise sides (e.g., the clockwise side). The other sides (e.g., counter-clockwise sides) of the various interface profiles can have a simple (e.g., rectangular) shape, which is the same among all three. Although the unique interface profiles have unique variations as described below, these variations can be incorporated into an otherwise simple (e.g., rectangular) shape. To provide its unique variation among the interface profiles, the first interface profile of the first jaw 171 and first slot 181 includes an additional step or shoulder 191 facing axially outward. To provide its unique variation among the interface profiles, the second interface profile of the second jaw 172 and second slot 182 includes an additional male-female interface (e.g., rib and slot) 192 spaced from both axial ends. In other words, the additional male-female interface 192 is a minor or secondary interface within the major or primary male-female interface between the second jaw 172 and the second slot 182. To provide its unique variation among the interface profiles, the third interface profile of the third jaw 173 and third slot 183 includes an additional step or shoulder 193 facing axially inward. When assembling the jaws 171, 172, 173 to the jaw plate 164 (prior to assembly with the hand wheel 170), each jaw 171, 172, 173 is slid radially inward into the corresponding slot 181, 182, 183 in the jaw plate 164, and the structures described above and illustrated in FIGS. 7-9 render it impossible to assemble any of the jaws 171, 172, 173 with any of the non-corresponding slots 181, 182, 183. Visual indicia (stickers or stampings with matching letters or numbers, etc.) can also be provided on the jaws 171, 172, 173 and jaw plate 164 to encourage efficient assembly effort, but these are no longer relied upon to make sure that the jaws are properly arranged within the chuck 88, 90.

Various features of the invention are set forth in the following claims.

What is claimed is:

1. A portable pipe threader comprising:
a collapsible stand;
a housing supported by the collapsible stand, the housing supporting a battery-powered drive assembly;
a first set of guide rails extending from a first end of the housing and supporting pipe threading tools; and
a second set of guide rails extending from a second end of the housing and supporting a roll groover, wherein the roll groover is configured to swing about a first one of the second set of guide rails to selectively engage a second one of the second set of guide rails.

2. The portable pipe threader of claim 1, further comprising a first chuck operable to clamp a pipe at the first end of the housing, and a second chuck operable to clamp a pipe at the second end of the housing, wherein the roll groover is aligned with the second chuck when engaged with the second one of the second set of guide rails.

3. The portable pipe threader of claim 1, wherein the roll groover has a closed cylindrical mount fully encircling the first one of the second set of guide rails, and wherein the roll groover has an open mount for selectively resting upon a top surface of the second one of the second set of guide rails.

4. The portable pipe threader of claim 3, wherein the roll groover includes a cross bar extending between the closed cylindrical mount and the open mount.

5. The portable pipe threader of claim 1, wherein the collapsible stand includes a first leg and a second leg coupled to the first leg, a wheel ground engagement member coupled to the first leg, and a non-wheel ground engagement member coupled to the second leg.

6. The portable pipe threader of claim 1, further comprising a mount positioned on a first end of the collapsible stand, wherein the mount is configured to be removably coupled to the threader.

7. A portable pipe threader comprising:
a collapsible stand including a first leg and a second leg coupled to the first leg with a first rotatable joint;
a housing supported by the collapsible stand, the housing supporting a battery-powered drive assembly;
an assist spring having a first end coupled to a lower portion of the first leg and a second end coupled to an upper portion of the second leg, the assist spring exerting a bias force urging the collapsible stand to an upright deployed position for supporting the housing at an elevated height above a work surface; and
an adjustable stop operable to toggle between a first, unlocked position in which the adjustable stop provides clearance for the second end of the assist spring to allow movement to the upright deployed position, and a second, locked position in which the adjustable stop is positioned to block movement of the second end of the assist spring to prevent movement to the upright deployed position.

8. The portable pipe threader of claim 7, wherein the adjustable stop consists of a rigid bracket pivotable between the unlocked and locked positions about a second rotatable joint on the first leg.

9. The portable pipe threader of claim 8, wherein the first rotatable joint engages the bracket to limit the range of movement thereof.

10. The portable pipe threader of claim 9, wherein the bracket includes a slot that receives the first rotatable joint.

11. The portable pipe threader of claim 8, wherein the adjustable stop has a pivotal range of 0 degrees to 10 degrees to move between the unlocked position and the locked position.

12. The portable pipe threader of claim 8, wherein an end of the bracket that is distal to the second rotatable joint is concave and complementary in shape to a rounded boss portion of a mount that secures the second end of the assist spring to the second leg.

13. The portable pipe threader of claim 7, wherein the assist spring is a gas spring.

14. The portable pipe threader of claim 7, wherein the assist spring is extendable and retractable in length, and wherein the assist spring is configured to extend along the first leg in a non-parallel orientation.

15. The portable pipe threader of claim 7, wherein a first end of the adjustable stop is pivotally coupled to the first rotatable joint, and a second end of the adjustable stop is positioned adjacent the second end of the assist spring.

16. A portable pipe threader comprising:
a housing supporting a battery-powered drive assembly;
a carriage supporting pipe threading tools at a first end of the housing; and
a spindle assembly including a chuck positioned at the first end for selectively clamping a pipe for rotation by the drive assembly about a central axis,
wherein the chuck includes
a plurality of jaws movable toward and away from the central axis,
a jaw plate slidingly supporting each of the plurality of jaws with a radial sliding interface, and
a scroll plate coupled to an internal side of each of the plurality of jaws and rotatable to simultaneously move the plurality of jaws toward or away from the central axis,
wherein the internal sides of the plurality of jaws differ from each other and only operate with concentricity when each of the plurality of jaws is in a prescribed position on the jaw plate, and
wherein improper positioning of the plurality of jaws on the jaw plate is prevented by providing sliding interface profiles that are different from each other such that interchangeability is prevented.

17. The portable pipe threader of claim 16, wherein the sliding interface profiles differ from each other on only one of a clockwise side or a counter-clockwise side.

18. The portable pipe threader of claim 16, wherein a first interface profile includes a step facing axially outward, wherein a second interface profile includes a male-female interface spaced from both axial ends, and wherein a third interface profile includes a step facing axially inward.

19. The portable pipe threader of claim 18, wherein the male-female interface includes a rib and a slot.

20. The portable pipe threader of claim 16, wherein the jaw plate includes a plurality of slots, and wherein the sliding interface profiles are configured to engage the plurality of slots.
